(19) United States
(12) Patent Application Publication
(10) Pub. No.: US 2007/0050172 A1
(43) Pub. Date: Mar. 1, 2007

(54) Method and apparatus for measuring throat areas of gas turbine engine nozzle assemblies

(75) Inventors: Wilson Frost, Cincinnati, OH (US); Daniel Edward Jones, Hamilton, OH (US); Scott Andrew Hoffman, Hilton Head, SC (US); Todd Gary Heinrich, Cincinnati, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/217,824

(22) Filed: Sep. 1, 2005

(51) Int. Cl. G01B 13/20

(52) U.S. Cl. 702/156

(57) ABSTRACT

A method for measuring a throat area of a turbine nozzle assembly that includes at least one airfoil extending between an inner band and an outer band is provided. The method includes locating a plurality of datum points on the at least one airfoil using a measuring system, measuring a plurality of measurement points within a flow path at least partly defined within the turbine nozzle assembly using the measuring system, comparing the plurality of datum points to a plurality of corresponding datum points measured on a baseline turbine nozzle assembly, and calculating a throat area variance between the measured turbine nozzle assembly and the baseline turbine nozzle assembly model based on the comparison to the baseline turbine nozzle assembly.

### BACKGROUND OF THE INVENTION

This invention relates generally to gas turbine engines, and more specifically to a method and apparatus for measuring gas turbine engine components.

Known gas turbine engines include combustors which ignite fuel-air mixtures that are channeled through a turbine nozzle assembly towards a turbine. At least some known turbine nozzle assemblies include a plurality of airfoils that are coupled together such that the members are spaced apart. Within such nozzle assemblies, the airfoil vanes are coupled together by inner and outer band platforms which form respective radially inner and outer flow path boundaries. At least some known methods for measuring a throat area of turbine nozzle assemblies that include a plurality of airfoils require the assembly to be completely manufactured before the throat area is measured.

The inner and outer band platforms of at least some known turbine nozzle assemblies are shaped using a grinder and are then brazed together to form the turbine nozzle assembly. However, because the grinding process may cause inconsistencies, accurately aligning the turbine nozzle airfoils with respect to the turbine nozzle assembly may be difficult. For example, one member can be slightly angled with respect to the adjacent member, and such misalignment may cause variations in the throat areas between adjacent airfoils which could adversely affect engine performance.

Accurate manufacturing of gas turbine engine components is a significant factor in determining both manufacturing timing and cost. Specifically, when the component is a gas turbine engine nozzle assembly, inaccurate manufacturing of nozzle assemblies with variations significantly increase overall manufacturing time and cost. Measuring nozzle assemblies identifies flaws or variations in the completed assemblies. Once these flaws or variations are identified, steps may be taken to prevent the manufacture of further variations. These nozzle assembly variations are often undesirable and can adversely affect not only overall gas turbine engine performance. Moreover, turbine nozzles which contain significant variations will likely have to be remanufactured, thus adding time and cost to the overall manufacture of the turbine engine.

### BRIEF DESCRIPTION OF THE INVENTION

In one aspect, a method for measuring a throat area of a turbine nozzle assembly that includes at least one airfoil extending between an inner band and an outer band is provided. The method includes locating a plurality of datum points on the at least one airfoil using a measuring system, measuring a plurality of measurement points within a flow path at least partly defined within the turbine nozzle assembly using the measuring system, comparing the plurality of datum points to a plurality of corresponding datum points measured on a baseline turbine nozzle assembly, and calculating a throat area variance between the measured turbine nozzle assembly and the baseline turbine nozzle assembly model based on the comparison to the baseline turbine nozzle assembly.

In another aspect, a measuring system configured to measure a throat area of a turbine nozzle assembly including at least one airfoil extending between an inner band and an outer band is provided. The measuring system includes a measuring device, a locating fixture operably coupled to the measuring device, and a computer coupled to the measuring device. The computer is configured to locate a plurality of datum points on the at least one airfoil using the measuring system, measure a plurality of measurement points within a flow path at least partly defined within the turbine nozzle assembly using the measuring system, compare the plurality of datum points to a plurality of corresponding datum points measured on a baseline turbine nozzle assembly, and calculate a throat area variance between the measured turbine nozzle assembly and the baseline turbine nozzle assembly model based on the comparison to the baseline turbine nozzle assembly.

### BRIEF DESCRIPTION OF THE DRAWINGS

FIG. 1 is a schematic illustration of a gas turbine engine;

FIG. 2 is a perspective view of an exemplary turbine nozzle assembly consisting of two airfoil segments that may be used in a gas turbine engine shown in FIG. 1;

FIG. 3 is a perspective view of an exemplary turbine nozzle assembly consisting of one airfoil;

FIG. 4 is a front view of a locating fixture assembly with the turbine nozzle assembly shown in FIG. 3 attached thereto;

FIG. 5 is a left side view of the locating fixture shown in FIG. 4;

FIG. 6 is a right side view of the locating fixture shown in FIG. 4; and

FIG. 7 is a perspective view of the measuring system which includes the locating fixture as shown in FIG. 4, a singlet as shown in FIG. 3, and a probe assembly;

FIG. 8 is a side view of the turbine nozzle airfoil shown in FIG. 3;

FIG. 9 is a perspective view of the turbine nozzle airfoil shown in FIG. 8;

FIG. 10 is a flow chart illustrating an exemplary method of measuring engine components.

### DETAILED DESCRIPTION OF THE INVENTION

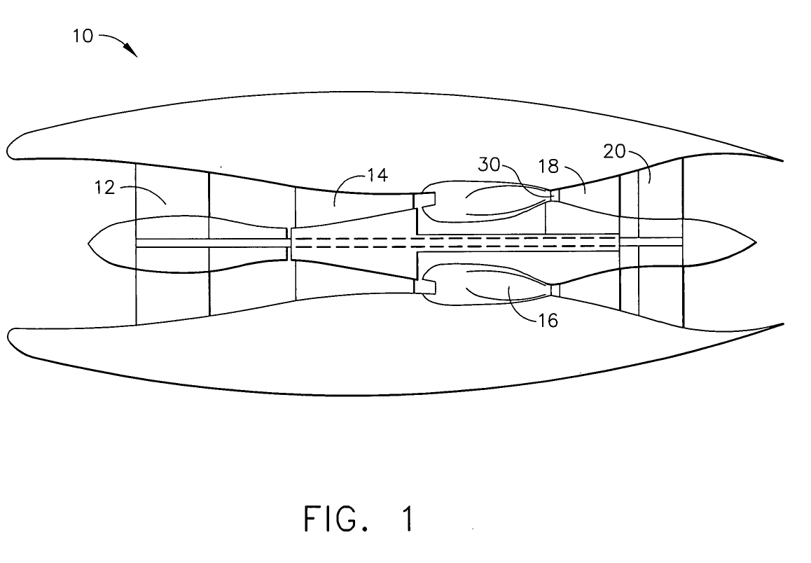

FIG. 1 is a schematic illustration of a gas turbine engine 10 including a low pressure compressor 12, a high pressure compressor 14, and a combustor 16. Engine 10 also includes a high pressure turbine 18 and a low pressure turbine 20.

In operation, air flows through low pressure compressor 12 and compressed air is supplied to high pressure compressor 14. The highly compressed air is delivered to combustor 16. The combustion exit gases are delivered from combustor 16 to a turbine nozzle assembly ring 30. Airflow (not shown) from combustor 16 drives turbines 18 and 20.

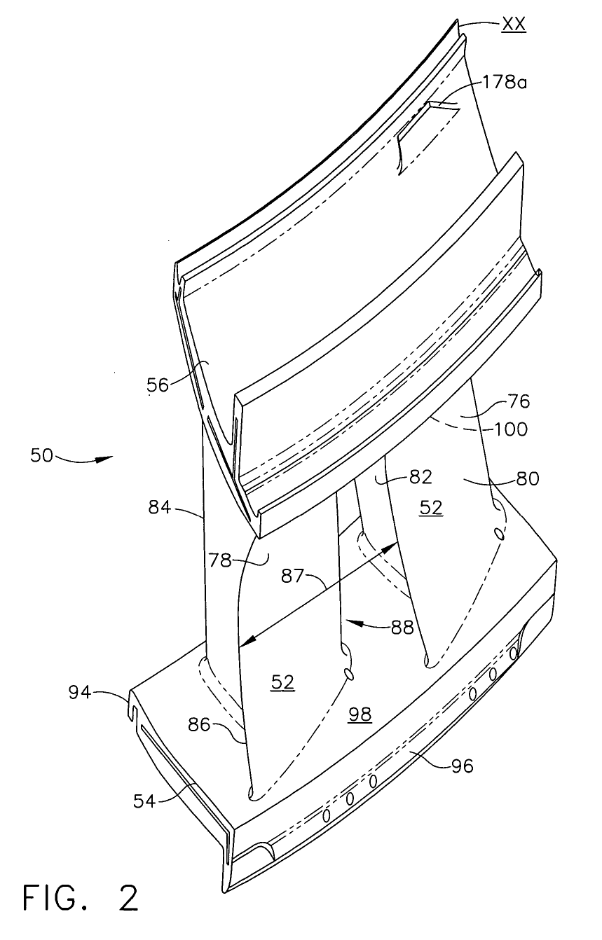

FIG. 2 is a perspective view of a turbine nozzle assembly 50 that may be used with engine 10 shown in FIG. 1. In the exemplary embodiment, nozzle assembly 50 includes two airfoils 52 and is generally known as a dublet. In such an embodiment, a plurality of turbine nozzle assemblies 50 are circumferentially coupled together to form turbine nozzle ring 30 (shown in FIG. 1).

In the exemplary embodiment, dublet 50 includes a plurality of circumferentially-spaced airfoils 52 coupled together by an arcuate radially outer band or platform 54, and an arcuate radially inner band or platform 56. More specifically, in the exemplary embodiment, each band 54 and 56 is integrally-formed with airfoil 52, and each dublet 50 includes two airfoils 52. In an alternative embodiment, a nozzle assembly that includes a single airfoil 52 and is generally known as a singlet. In yet another alternative embodiment, a nozzle assembly that includes three airfoils 52 is generally known as a triplet.

In the exemplary embodiment, airfoils 52 are substantially identical and each nozzle segment 50 includes a leading airfoil 76 and a trailing airfoil 78. Each individual airfoil 52 includes a first sidewall 80 and a second sidewall 82. First sidewall 80 is convex and defines a suction side of each airfoil 52, and second sidewall 82 is concave and defines a pressure side of each airfoil 52. Sidewalls 80 and 82 are joined at a leading edge 84 and at an axially-spaced trailing edge 86 of each airfoil 52. Each airfoil trailing edge 86 is spaced chordwise and downstream from each respective airfoil leading edge 84. First and second sidewalls 80 and 82, respectively, extend longitudinally, or radially outwardly, in span from radially inner band 56 to radially outer band 54 and are separated by a distance 87 such that a throat area 88 is defined between each airfoil 52.

In the exemplary embodiment, outer band 54 includes a radially inner surface 98 and inner band 56 includes a radially inner surface 100. Inner surfaces 98 and 100 define a flow path for combustion gases to flow through nozzle segment 50. In the exemplary embodiment, the combustion gases are channeled through nozzle segments 50 to turbines 18 or 20 (shown in FIG. 1).

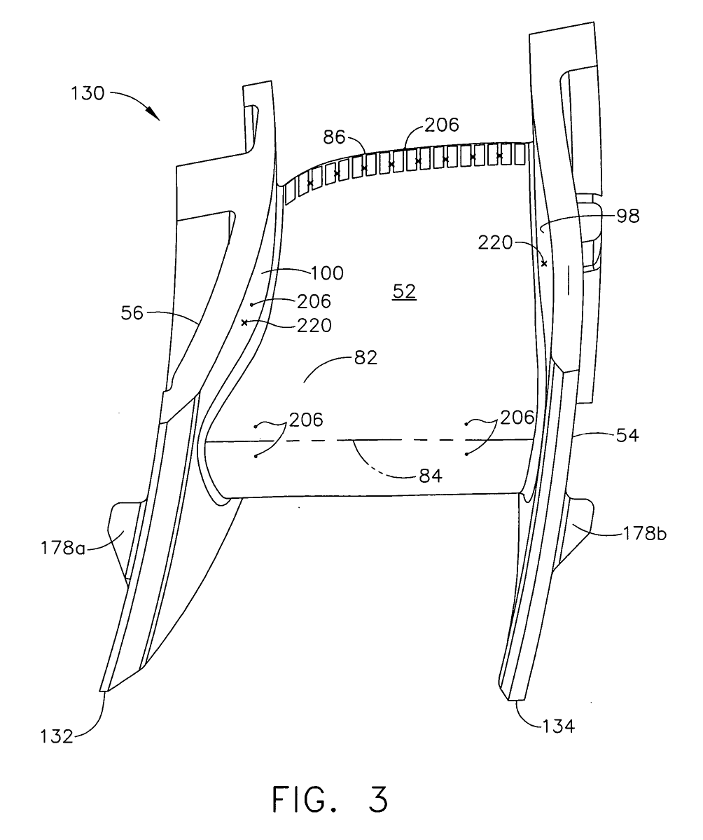

FIG. 3 is a front view a nozzle assembly singlet 130. In the exemplary embodiment singlet 130 represents half of dublet 50, as shown in FIG. 2. Singlet 130 consists of a single airfoil 52 which consists of second sidewall 82, a leading edge 84 and a trailing edge 86. Airfoil 52 is positioned between an inner band 56 and an outer band 54. Inner band 56 consists of inner surface 100, an outer protrusion 178a and an inner band edge corner 132. Outer band 54 consists of inner surface 98, an outer protrusion 178b, and an outer band edge corner 134. In the exemplary embodiment singlet 130, datum points 206 are positioned in various positions on airfoil 52 and inner band inner surfaces 100. Furthermore, measurement points 220 are positioned in various locations on airfoil trailing edge 86, inner band inner surface 100, and outer band inner surface 98.

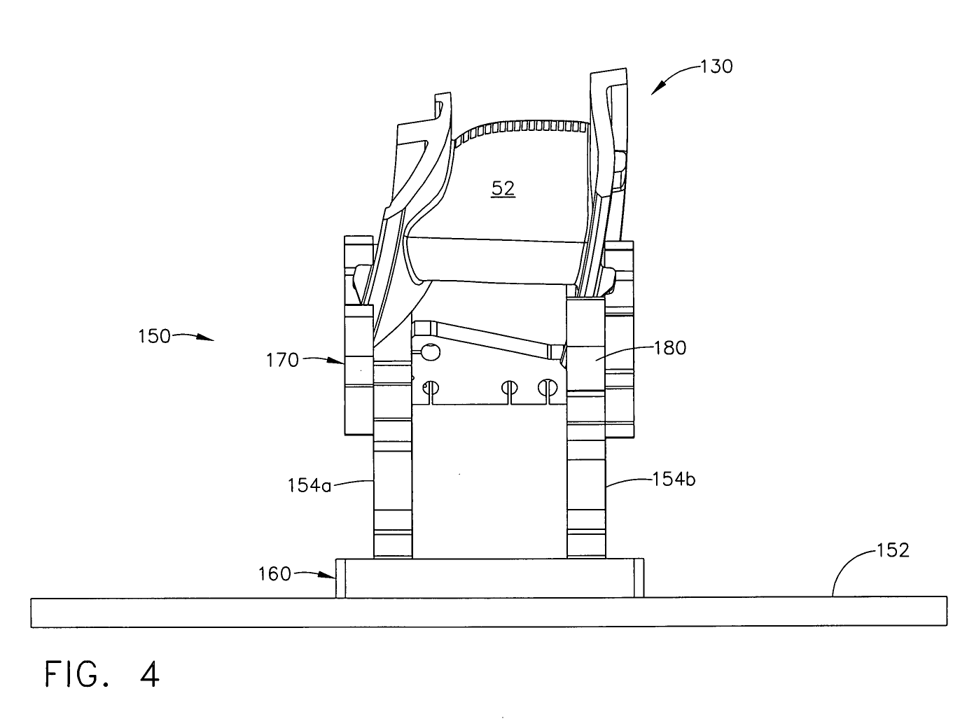

FIG. 4 is a front view of a locating fixture 150 mounted to a base plate 152. In the exemplary embodiment, locating fixture 150 includes two support legs 154a and 154b. Each support leg 154a and 154b is coupled to a locating fixture base member 160. Additionally, in the exemplary embodiment, left and right clamping mechanisms 170 and 180 are connected to the top of each support leg 154a and 154b. Clamping mechanisms 170 and 180 are uniquely designed to clamp specific nozzle assembly designs. In the exemplary embodiment, uniquely designed spring clamps ensure that nozzle assembly 130 is held so that proper measuring can be conducted and no damage is inflicted on nozzle assembly singlet 130.

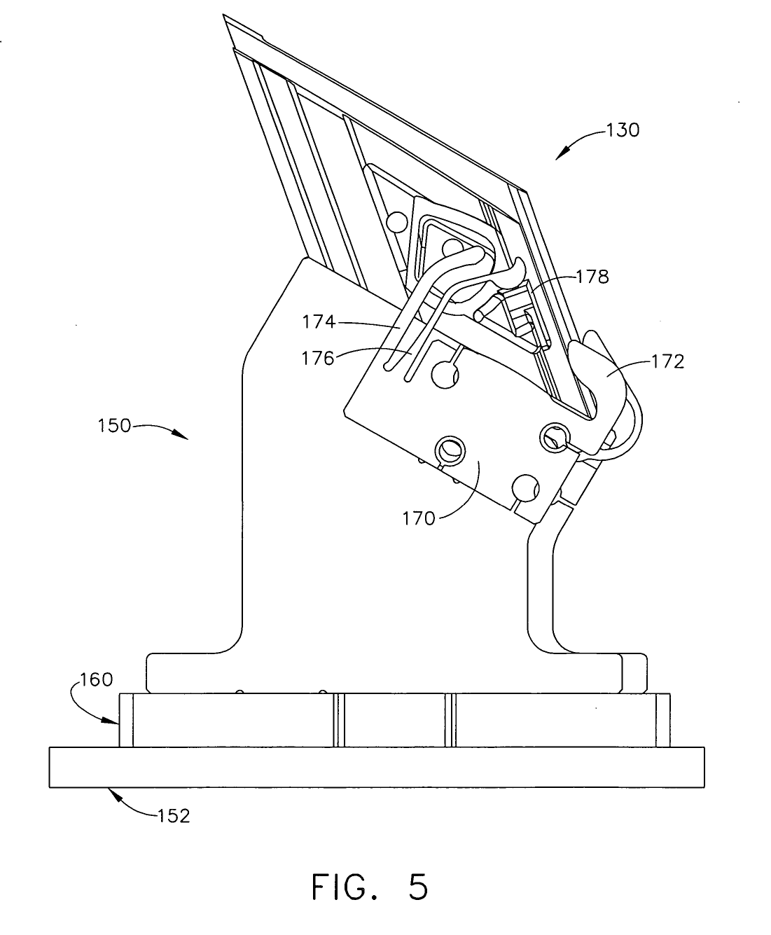

FIG. 5 is a left side view of locating fixture 150 with singlet 130 mounted therein. Left clamping mechanism 170 includes an anchoring member 172 and two biasing members 174 and 176. Biasing members 174 and 176 bias singlet 130 towards anchoring member 172. Biasing members 174 and 176 apply downward force on outer protrusions 178a toward the anchoring retaining member 172 which firmly holds inner band edge corner 132.

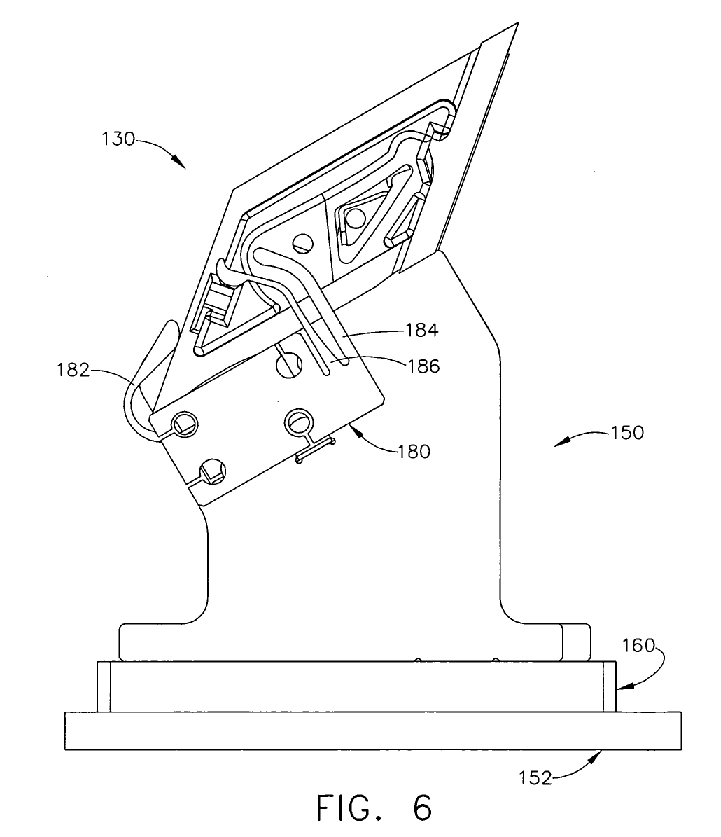

FIG. 6 is a right side view of locating fixture 150 with singlet 130 mounted therein. Right clamping mechanism 180 includes a flexible spring clip 182 and two biasing members 184 and 186. Biasing members 184 and 186 bias singlet 130 towards flexible spring clip 182. Biasing members 184 and 186 apply downward force on nozzle assembly protrusion 178b toward flexible spring clip 182 which applies opposing biasing force.

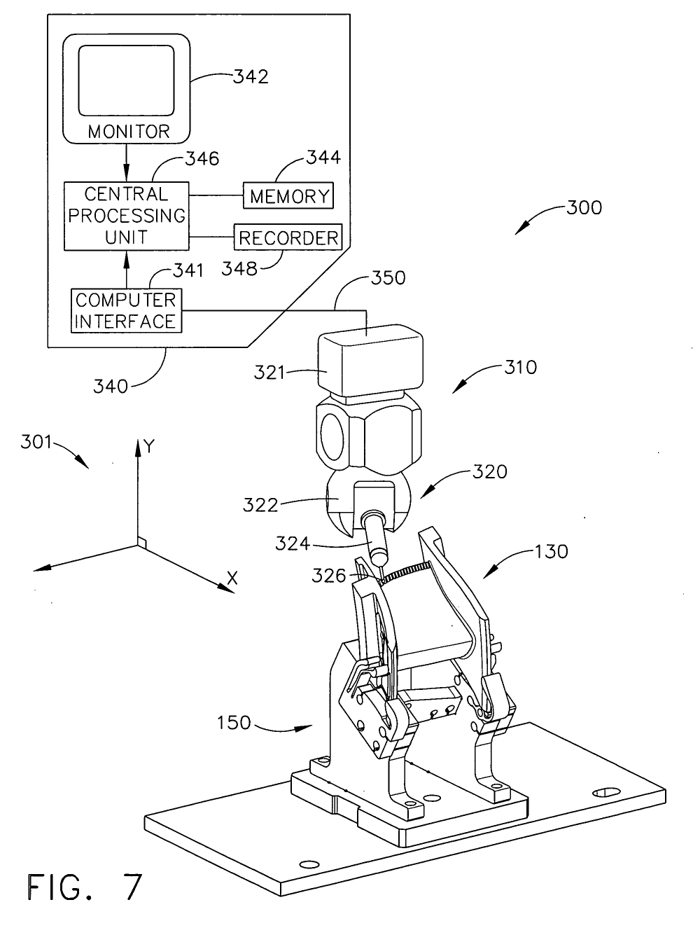

FIG. 7 is a perspective view of an exemplary measuring system 300 that can be used to measure engine components such as, but not limited to, a turbine nozzle singlet 130 which may be used with gas turbine engine 10. In the exemplary embodiment, measuring system 300 includes a measuring device 310, a computer 340 and locating fixture 150. Measuring device 310 includes a measuring device arm 312 and a probe assembly 320. Probe assembly 320 includes a probe manipulator 322, a probe arm 324, and a probe tip 326. Probe assembly 320 is electrically coupled to computer 340 such that information can be transmitted to/from probe assembly 320 and computer 340. Locating fixture 150 is configured to position singlet 130 such that the probe assembly 320 can measure the airfoil pressure side 82, airfoil suction side 80, leading edge 84, trailing edge 86, inner band surface 100 and outer band surface 98.

Computer 340 includes a computer interface 341, a central processing unit (CPU) 346, a memory 344, and a monitor 342. Computer interface 341 allows information to be entered into computer 340. Computer 340 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

Memory 344 is intended to represent one or more volatile and/or nonvolatile storage facilities that shall be familiar to those skilled in the art. Examples of such storage facilities often used with computer 340 include, but are not limited to, solid state memory (e.g., random access memory (RAM), read-only memory (ROM), and flash memory), magnetic storage devices (e.g., floppy disks and hard disks), and/or optical storage devices (e.g., CD-ROM, CD-RW, and DVD). Memory 344 may be internal or external to computer 340. Computer 340 also includes a recording device 348 such as, but not limited to, a strip chart recorder, a C-scan, and an electronic recorder that is electrically coupled to either computer 340 and/or measuring device 310.

Locating fixture 150 is configured to position singlet 130 such that any part of the flow path may be measured by probe assembly 320 while minimizing the distance traveled by probe tip 326.

In use, singlet 130 is mounted to locating fixture 150 to secure singlet 130 in place during measurement. Probe assembly 320 includes probe tip 326 that is coupled to probe arm 324 which is coupled to probe manipulator 322. Probe assembly 320 is electrically connected to computer 340 by a data link 350. The actions of the probe assembly are controlled by computer 340. Coordinate information for every datum point 206 and measurement point 220 is received by computer 340 over data link 350.

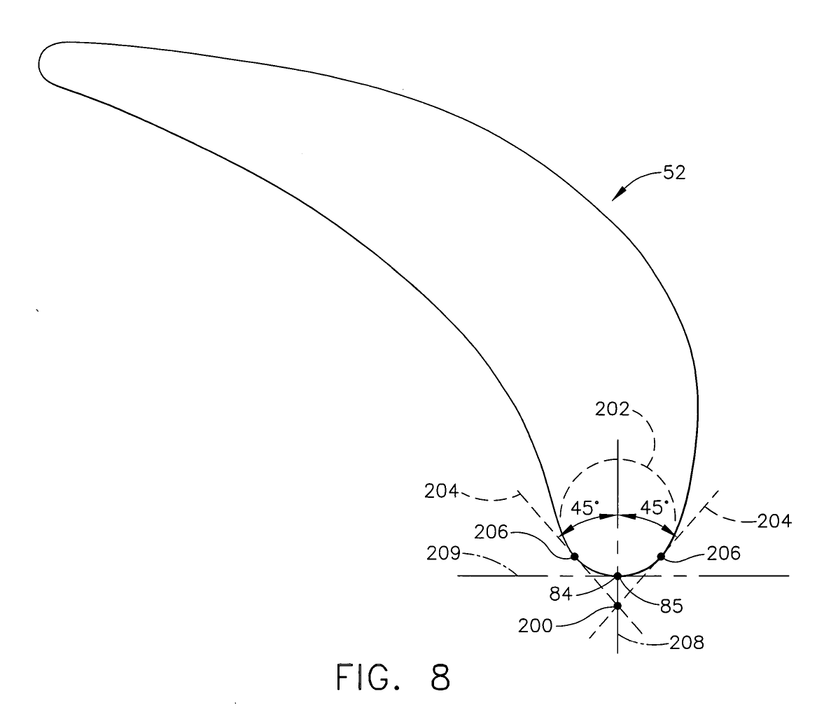

FIG. 8 is a side view of airfoil 52. Leading edge 84 represents a line on a curved surface which is tangential to a perpendicular plane 209. If the curvature of the curved surface is extended and traced into a circle, a cylindrical structure 202 is found to be inscribed within the front portion of airfoil 52.

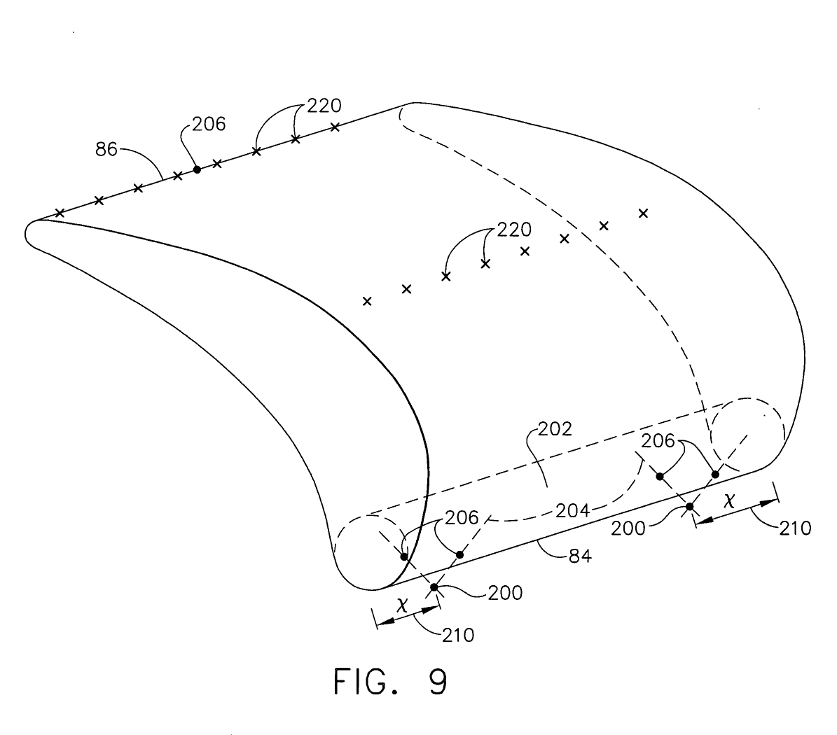

FIG. 9 is a perspective view of airfoil 52 that shows inscribed cylindrical structure 202. Datum points 206 are positioned circumferentially away from leading edge 84 on the surface of cylindrical structure 202. In the exemplary embodiment, the four datum points 206 located near leading edge 84 also represent points where cylindrical structure 202 is tangential to perpendicular planes 204, herein after referred to as datum point tangent planes 204. In the exemplary embodiment, datum point tangent planes 204 intersect each other at a right angle point of intersection 200 which is in line with leading edge 84. Point of intersection 200 and leading edge 84 form line 208 that is forty-five degrees from each datum point 206.

In the exemplary embodiment, four datum points 206 are located near leading edge 84. Datum points 206 are located at a distance ‘x’ away from inner band surface 100 and outer band surface 98. Another datum point 206 is located on trailing edge 86. A sixth datum point 206 is located on inner band surface 100 as shown in FIG. 3.

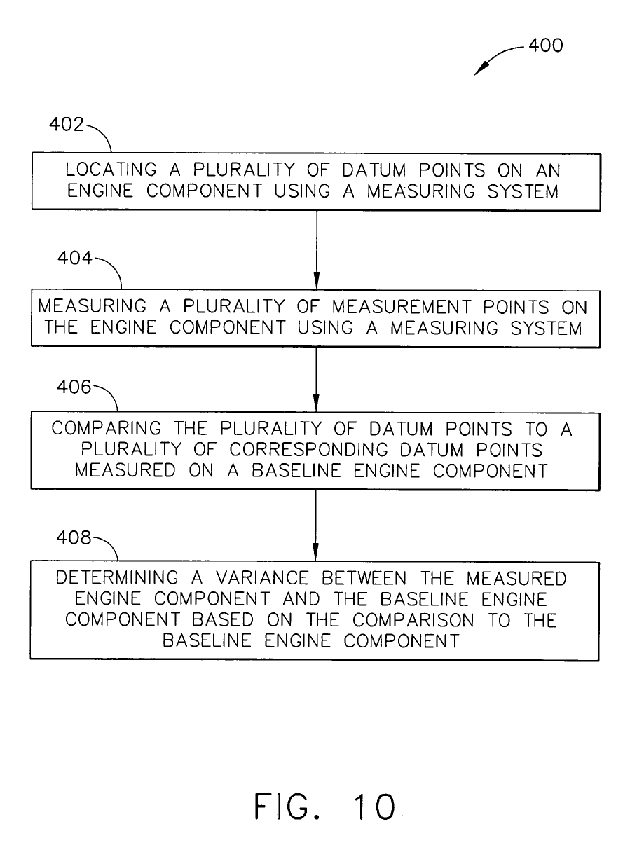

FIG. 10 is a flow chart illustrating an exemplary method 400 for measuring an engine component. Method 400 includes locating 402 a plurality of datum points on an engine component using a measuring system, measuring 404 a plurality of measurement points on the engine component using the measuring system, comparing 406 the plurality of datum points to a plurality of corresponding datum points measured on a baseline engine component, and determining 408 a variance between the measured engine component and the baseline engine component based on the comparison to the baseline engine component.

During operation of the exemplary embodiment, singlet 130 is mounted on locating fixture 150. The position of locating fixture 150 and mounted singlet 130 is generally known by computer 340. To accurately measure engine components, measuring system 300 measures each measurement point 220 on a component in reference to a datum point 206. This allows measuring system 300 to accurately measure components which may be placed in different positions than the previously measured components within measuring system 300. An identification number that is unique to the specific nozzle design is entered into computer 340. Computer 340 generates a three dimensional (3D) baseline turbine nozzle model (not shown), which has previously been entered into computer 340. The baseline nozzle model contains the exact specifications to which each nozzle assembly 50 for a particular nozzle ring is manufactured. In the exemplary embodiment, the baseline nozzle assembly model identifies the locations of datum points 206 and measurement points 220 on singlet 130. In the exemplary embodiment, computer 340 utilizes the 3D model to facilitate directing probe tip 326 to locate and measure datum points 206 and measurement points 220, respectively.

Datum points 206 are unique to each nozzle assembly design. Although the exemplary embodiment illustrates six datum points 206, it should be realized that measuring system 300 may position probe tip 326 at any quantity of datum points 206 at any position on the turbine nozzle assembly without affecting the scope of the method described herein. Positions of datum points 206 are each sent to computer 340 for example for further processing. More specifically, positions of datum points 206 are utilized to adjust coordinate system 301 of measuring system 300. This adjustment of coordinate system 301 accounts for inconsistencies in measurements due to inconsistent nozzle assembly mounting or calibration error.

In the exemplary embodiment, once the locations of datum points 206 have been obtained, computer 340 directs probe tip 326 to measure pre-defined measurement points 220. Measurement points 220 are measured along airfoil trailing edge 86, airfoil suction side 80, inner band inner surface 100 and outer band inner surface 98. In the exemplary embodiment, measurement points 220 are utilized to determine throat area 88 of a turbine nozzle assembly 50. In the exemplary embodiment, eight measurement points 220 are located on trailing edge 86. Eight additional points are located on suction side 80. One measurement point is located on the inner band surface 100 and another point is located on the outer band surface 98. Although the exemplary embodiment illustrates eighteen measurement points 220, it should be realized that measuring system 300 may position probe tip 326 at any quantity of measurement points 220, for example at least six measurement points 220, at any position in the turbine nozzle assembly flow path without affecting the scope of the method described herein.

In operation, computer 340 utilizes measurement points 220 to generate a 3D drawing of singlet 130. The 3D drawing includes the location of datum points 206 and measurement points 220. Computer 340 combines the 3D drawing of singlet 130 with the baseline 3D nozzle model. The two 3D drawings are lined up according to datum points 206. The resulting 3D drawing allows computer 340 to compare the differences between measurement points 220 from singlet 130 and the measurement points from the baseline nozzle assembly. Computer 340 utilizes the variance between the model nozzle assembly and the measured nozzle assembly to determine the estimated throat area 88 of a constructed dublet 50.

In the exemplary embodiment, computer 340 receives the physical nozzle measurement points 220 and determines the estimated throat area 88 of turbine nozzle assembly 50. The throat area 88 of a nozzle assembly containing at least two airfoils 52 can be determined using the measurement of only a single airfoil 52. Throat area 88 is calculated by measuring the width and height of two adjacent airfoils 52 in a nozzle assembly 50. The estimated throat area 88 of a single airfoil 52 can be determined by computer 340 utilizing the measurement points 220 of the physical nozzle singlet 130 that includes one airfoil 52 and a baseline model that includes the representation of a benchmark airfoil. Computer 340 then uses datum points 206 of the measured airfoil and the datum points of the baseline airfoil to place the two airfoils adjacent each other as a completed nozzle assembly dublet. Computer 340 then determines the estimated throat area of a turbine nozzle assembly that includes a first physical measured airfoil and a second computer generated airfoil model.

Exemplary embodiments of measurement systems are described above in detail. The systems are not limited to the specific embodiments described herein, but rather, components of each system may be utilized independently and separately from other components described herein. Each system component can also be used in combination with other system components. More specifically, although the methods and apparatus herein are described with respect to aircraft engine parts, it should be appreciated that the methods and apparatus can also be applied to a wide variety of components used within a steam turbine, a nuclear power plant, an automotive engine, or to inspect any mechanical component.

While the invention has been described in terms of various specific embodiments, those skilled in the art will recognize that the invention can be practiced with modification within the spirit and scope of the claims.

What is claimed is:

1. A method for measuring a throat area of a turbine nozzle assembly that includes at least one airfoil extending between an inner band and an outer band, said method comprising:
locating a plurality of datum points on the at least one airfoil using a measuring system;
measuring a plurality of measurement points within a flow path at least partly defined within the turbine nozzle assembly using the measuring system;
comparing the plurality of datum points to a plurality of corresponding datum points measured on a baseline turbine nozzle assembly; and
calculating a throat area variance between the measured turbine nozzle assembly and the baseline turbine nozzle assembly model based on the comparison to the baseline turbine nozzle assembly.

2. A method in accordance with claim 1 further comprising determining any differences between the measured plurality of measurement points on the turbine nozzle assembly and the corresponding plurality of measurement points on the baseline turbine nozzle assembly model.

3. A method in accordance with claim 1 wherein locating the plurality of datum points further comprises:
entering a turbine nozzle identification number into the measuring system;
generating a baseline turbine nozzle assembly model utilizing the identification number;
identifying datum points on the baseline turbine nozzle assembly model that have been previously entered into the measuring system; and
locating a corresponding plurality of datum points on the turbine nozzle assembly utilizing the previously entered baseline turbine nozzle assembly model datum points.

4. A method in accordance with claim 1 wherein locating the plurality of datum points further comprises locating at least six datum points in the turbine nozzle assembly flow path.

5. A method in accordance with claim 1 wherein measuring the plurality of measurement points further comprises:
identifying a plurality of measurement points on the baseline turbine nozzle model that have been previously entered into the measuring system; and
measuring the corresponding plurality of measurement points on the turbine nozzle assembly utilizing the previously entered turbine nozzle model measurement points.

6. A method in accordance with claim 1 wherein measuring the plurality of measurement points further comprises measuring at least six points on the airfoil trailing edge, airfoil suction side, inner band and outer band.

7. A method in accordance with claim 1 wherein comparing the datum points of the turbine nozzle assembly to a plurality of corresponding datum points measured on a baseline turbine nozzle assembly further comprises entering baseline turbine nozzle datum point coordinates into the measuring system computer.

8. A method in accordance with claim 1 further comprising coupling the turbine nozzle to a measuring device further comprises coupling the turbine nozzle to a locating fixture.

9. A method in accordance with claim 8 wherein coupling the turbine nozzle assembly to a locating fixture further comprises positioning the turbine nozzle in the locating fixture such that the at least the airfoil pressure side and suction side can be measured by a measuring probe.

10. A measuring system configured to measure a throat area of a turbine nozzle assembly that includes at least one airfoil extending between an inner band and an outer band, said measuring system comprising:
a measuring device;
a locating fixture operably coupled to said measuring device; and
a computer coupled to said measuring device wherein said computer is configured to:
locate a plurality of datum points on the at least one airfoil using said measuring system;
measure a plurality of measurement points within a flow path at least partly defined within said turbine nozzle assembly using said measuring system;
compare the plurality of datum points to a plurality of corresponding datum points measured on a baseline turbine nozzle assembly; and
calculate a throat area variance between the measured turbine nozzle assembly and the baseline turbine nozzle assembly model based on the comparison to the baseline turbine nozzle assembly.

11. A system in accordance with claim 10 wherein said measuring system is further configured to determine any differences between the measured plurality of measurement points on the turbine nozzle assembly and the corresponding plurality of measurement points on the baseline turbine nozzle assembly model.

12. A system in accordance with claim 10 wherein said system is further configured to:
receive a turbine nozzle identification number;
generate a baseline turbine nozzle assembly model utilizing the identification number;
identify datum points on the baseline turbine nozzle assembly model that have been previously entered into the measuring system; and
locate a corresponding plurality of datum points on the turbine nozzle assembly utilizing the previously entered baseline turbine nozzle assembly model datum points.

13. A system in accordance with claim 10 wherein said system is further configured to locate at least six datum points in said turbine nozzle assembly flow path utilizing said measuring device.

14. A system in accordance with claim 10 wherein said system is further configured to:
identify a plurality of measurement points on said baseline turbine nozzle assembly model that have been previously entered into said measuring system; and
measure the corresponding plurality of measurement points on the turbine nozzle assembly utilizing the previously entered baseline turbine nozzle assembly model measurement points.

15. A system in accordance with claim 10 wherein said system is further configured to measure at least six points on an airfoil trailing edge, airfoil suction side, inner band and outer band.

16. A system in accordance with claim 10 wherein said system is further configured to compare said datum points of the turbine nozzle assembly to a plurality of corresponding datum points of a baseline turbine nozzle assembly.

17. A system in accordance with claim 10 wherein said locating fixture further comprises:
a base plate;
a support member coupled to said base plate; and
a clamping mechanism coupled to said support member.

18. A system in accordance with claim 17 wherein said locating fixture is configured to interchangeably receive uniquely designed clamping mechanisms.

19. A system in accordance with claim 10 wherein said measuring device further comprises a measuring probe.
